(19) United States
(12) Patent Application Publication
(10) Pub. No.: US 2022/0327449 A1
(43) Pub. Date: Oct. 13, 2022

(54) BUSINESS PROCESSES OPTIMIZATION USING NON-DETERMINISTIC PLANNING

(71) Applicant: International Business Machines Corporation, Armonk, NY (US)

(72) Inventors: Tathagata Chakraborti, Cambridge, MA (US); Sarath Sreedharan, Tempe, AZ (US); Shubham Agarwal, Cambridge, MA (US); Yasaman Khazaeni, Needham, MA (US); Yara Rizk, Cambridge, MA (US); Vatche Isahagian, Belmont, MA (US)

(21) Appl. No.: 17/226,357

(22) Filed: Apr. 9, 2021

(51) Int. Cl. G06Q 10/06; G06Q 10/04

(52) U.S. Cl. CPC G06Q 10/06311; G06Q 10/04

(57) ABSTRACT

An optimization method, system, and computer program product for a number of tasks within a business process that can be automated that includes receiving access to an electronic representation of the business process, optimizing the business process to develop an optimized business process, displaying the optimized business process as a storyboard using storyboarding, and receiving an edit of the optimized business process, and automatically making a further edit to the optimized business process.

### BACKGROUND

The present invention relates generally to an optimization method, and more particularly, but not by way of limitation, to a system, method, and computer program product for optimization of a business process using storyboarding.

Conventionally, the design of sophisticated goal-directed conversational agents (i.e., for applications such as customer support) requires a dialogue designer to either manually specify an entire dialogue plan or train end-to-end systems from existing logs of conversation. The former becomes intractable fairly rapidly which means conversational agents of any reasonable sophistication are still comfortably out of reach, while the latter provides no control over the emergent behavior of the agent. Thus, the conventional techniques are unusable in the enterprise scene where the customer experience has to be guaranteed to a reasonable certainty.

Conventional techniques include an agent-centric view of the world where a dialogue designer specifies “capabilities” that are available to an agent and lets a non-deterministic planner generate and execute the composed dialogue plan in the background. However, this can lead to an exponential scale-up from the size of the specification to the complexity of the composed agent, as an illustration of the exciting fusion of planning-based technologies (e.g., especially non-deterministic planning) and the design of dialogue agents. This is especially useful in the design of certain kinds of conversations, especially ones with an underlying process (e.g., a business process) that drives the conversation. These conventional solutions provide a powerful tool for an experienced domain writer with expertise in planning, and declarative programming in general. However, for the novice designer it presents too steep a learning curve. Since designers no longer explicitly compose the dialogue plan, they lose control over the composed agent if they do not grasp the imperative consequences of their declarative specification.

### SUMMARY

Thus, the inventors have considered a technical solution to the technical problem in the conventional techniques by making a core domain-authoring engine more amenable to dialogue and automation designers who are outside a planning community and do not readily subscribe to the declarative mental mode. Thus, the invention represents a new, low-effort approach to managing and optimizing complex business processes offline, while enabling scalability for business process management tools with artificial intelligence and automation. The optimization includes a specific kind of optimization where the amount of automation is being maximized (i.e., skills being the unit of automation).

In an exemplary embodiment, the present invention can provide a computer-implemented optimization method, the method including receiving access to an electronic representation of a business process, optimizing the business process to develop an optimized business process, displaying the automated business process as a storyboard using storyboarding, and receiving an edit of the optimized business process, and automatically making further edits to the optimized business process.

Other details and embodiments of the invention are described below, so that the present contribution to the art can be better appreciated. Nonetheless, the invention is not limited in its application to such details, phraseology, terminology, illustrations and/or arrangements set forth in the description or shown in the drawings.

Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIG. 1 exemplarily shows a high-level flow chart for an optimization method 100;

FIGS. 2-3 exemplarily depict an example of an existing business process;

FIG. 4 exemplarily depicts an optimized business process according to the method 100;

FIG. 5 exemplarily depicts an interface for using the method 100;

FIG. 6 exemplarily depicts a write-test-debug cycle via storyboarding according to the method 100;

FIGS. 7-10 exemplarily depict examples of generated dialogue graphs of the method 100;

FIG. 11 exemplarily depicts a scaling of the write-test-debug cycle to identify failure rates;

FIG. 12 depicts a cloud computing node 10 according to an embodiment of the present invention;

FIG. 13 depicts a cloud computing environment 50 according to an embodiment of the present invention; and

FIG. 14 depicts abstraction model layers according to an embodiment of the present invention.

### DETAILED DESCRIPTION

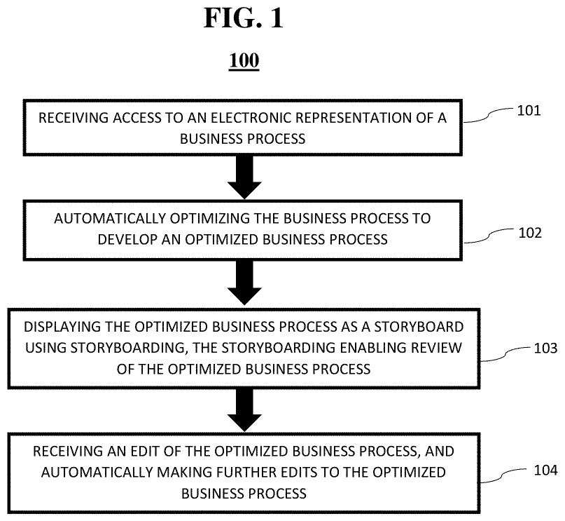

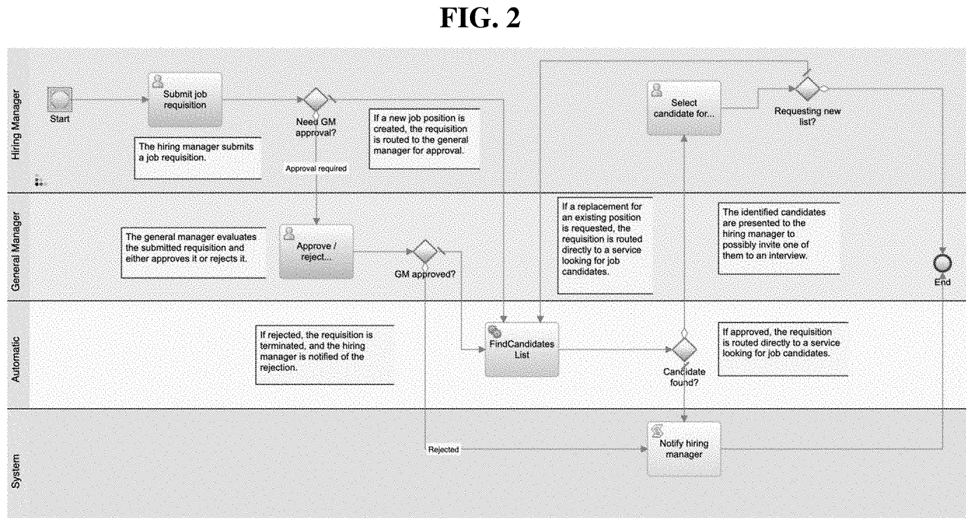

The invention will now be described with reference to FIG. 1-14, in which like reference numerals refer to like parts throughout. It is emphasized that, according to common practice, the various features of the drawing are not necessarily to scale. On the contrary, the dimensions of the various features can be arbitrarily expanded or reduced for clarity,

With reference now to the exemplary method 100 depicted in FIG. 1, the optimization method 100 includes various steps for a way to interact and ablate on an output of a planner and use non-deterministic planning as a substrate to generate the output which leads to concepts such as storyboarding, minimal abstraction, and the test-debug cycle using the abstraction and storyboarding and simulation.

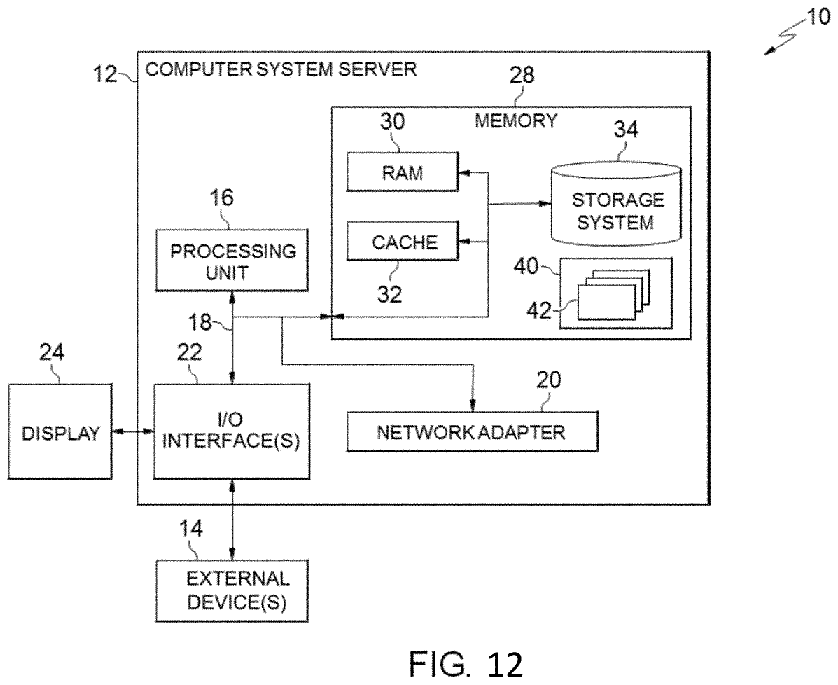

As shown in at least FIG. 12, one or more computers of a computer system 12 according to an embodiment of the present invention can include a memory 28 having instructions stored in a storage system to perform the steps of FIG. 1.

The optimization method 100 according to an embodiment of the present invention may act in a more sophisticated, useful and cognitive manner, giving the impression of cognitive mental abilities and processes related to knowledge, attention, memory, judgment and evaluation, reasoning, and advanced computation, A system can be said to be “cognitive” if it possesses macro-scale properties—perception, goal-oriented behavior, learning/memory and action—that characterize systems (i.e., humans) generally recognized as cognitive.

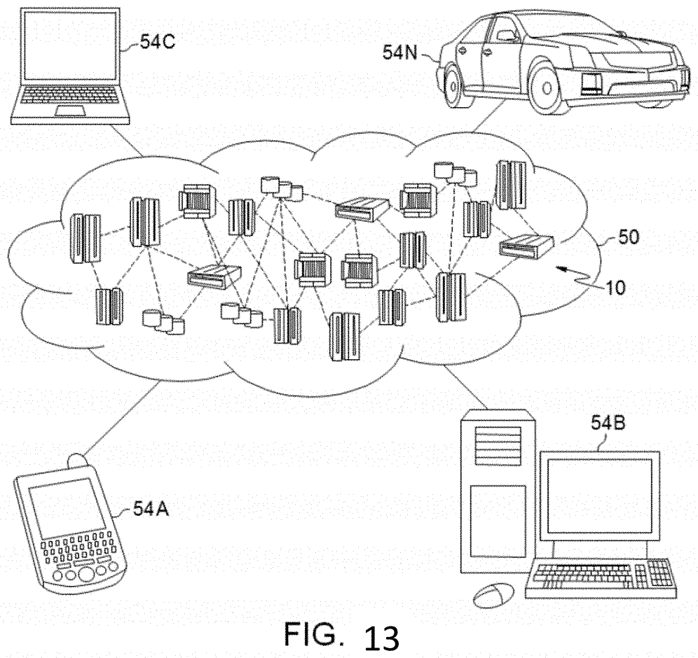

Although one or more embodiments (see e.g., FIGS. 12-14) may be implemented in a cloud environment 50 (see e.g., FIG. 13), it is nonetheless understood that the present invention can be implemented outside of the cloud environment.

With reference generally to FIGS. 1-11, FIGS. 2-3 depict a business process that is represented as an automatic state machine, Business Process Model and Notation (BPMN) specification, etc. The invention includes a specific type of optimization where an amount of automation is optimized using skills, wherever possible. The planner's job is to figure out such opportunities, and fallbacks to the original process, wherever possible. A skill catalog (i.e., commercially available) may contain thousands of skills that can be composed in numerous and sophisticated ways. A skill is an atomic unit of automation, implemented as a function in code. The source of skills and business processes may be different. Moreover, properties of skills (e.g. cost, accuracy, latency, etc.) may change, and hence the optimal composition can evolve.

With reference now to the method 100 of FIG. 1, the method 100 may change, evolve, and optimize a business process by injecting services into the business process that can perform specific computations, while at the same time providing the person in charge of the process tools to manage it easily. To achieve this, the method 100 builds on a substrate of non-deterministic planning so as to be able to compute the composed process offline and allow the process manager to analyze and edit the composed process while also being able to plan for the inherent uncertain nature of execution with external services.

More specifically, in step 101, access to an electronic representation of a business process is received. In step 102, the business process is automatically optimized to develop an optimized business process.

Then, in step 103, the (automated) optimized business process is displayed as a storyboard using storyboarding, the storyboarding enabling a review of the optimized business process. And, in step 104, an edit of the optimized business process is received, and further edits to the optimized business process are automatically made.

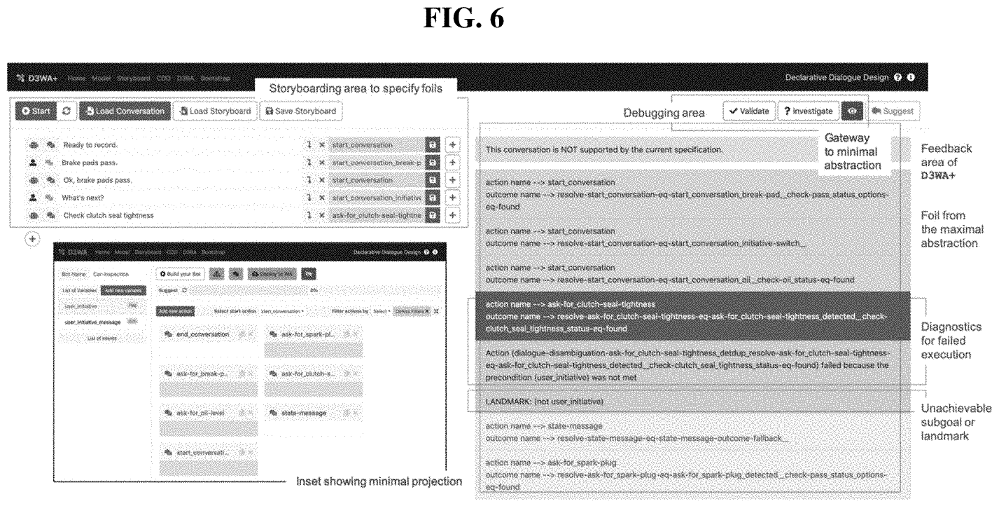

That is, an administrator may interact with the optimized composition from the planner through a “write-test-debug” cycle facilitated by a storyboarding interface that is generated via step 103 and as depicted in FIG. 6. Storyboarding allows the administrator of the process to write out stories or examples of what they want and what they do not want, and to query the composed model with it. The planner responds with a proof that the user request can be enforced or an explanation if it cannot be enforced.

Indeed, the method 100 includes a non-deterministic planner that receives the specification, plans for all possible outcomes, and generates the resulting dialogue plans. This offline approach has at least two advantages in that it allows the dialogue designer to inspect and sign off on the agent to be deployed, while also being able to support complex dialogues without having to plan (and re-plan) in real-time.

The method 100 further provides a suite of debugging tools (i.e., storyboarding, abstraction, and/or simulation) on top of the existing core model acquisition framework described above. This aims to make the dialogue designer more self-sufficient when the designer is faced with modeling errors. Specifically, based on difficulties observed during preliminary internal testing, the method 100 tackles two core issues (e.g., the specification cannot be solved by the planner and the solution does not match expectations) faced frequently by dialogue designers grappling with the declarative paradigm.

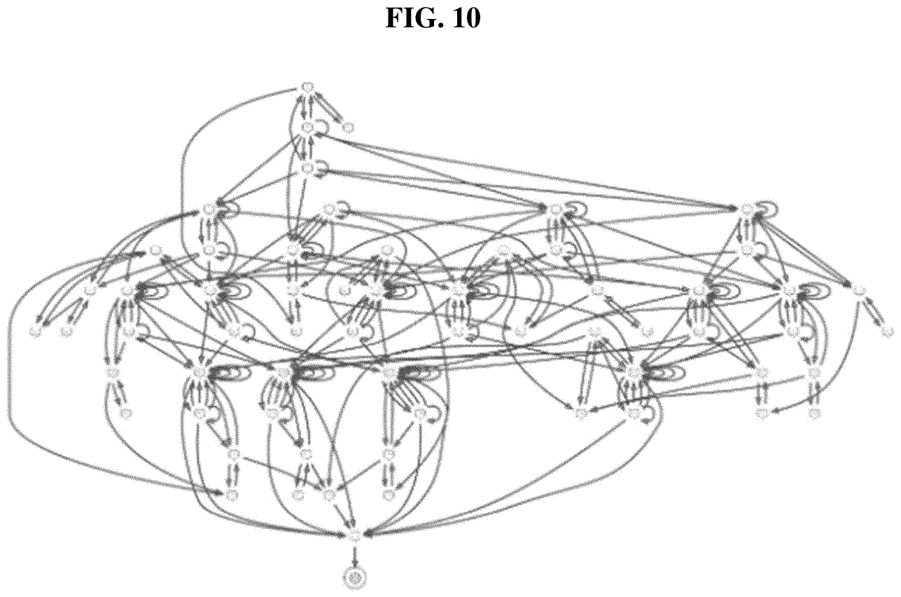

For when the specification cannot be solved by the planner, this is the case when the graph in FIG. 10 does not appear at all, and the dialogue designer is left with an inscrutable “no solution found” message and nothing else to work with. The goal here is to provide surface features from the current specification back to the designer so that they can fix or identify the root cause of the unsolvability.

For when the solution does not match expectations, the problem is solvable but the solution does not match the designer's expectations (i.e., the graph in FIG. 10 looks nothing like what they were aiming for). The goal here is to be able to respond to questions from the designer such as “Why is this a solution?” and “Why is this not a solution?”, so that one can modify the specification accordingly until the designer is satisfied with the outcome. It is noted that the setting here involves the domain designer and not the end user.

Thus, the suite of challenges includes the explanatory dialogue that is geared towards the model acquisition task rather than the exploration of the decision-making process.

One basis for the method 100 is a planning problem II where M [symbol] {π} takes in as input a model M= [symbol] F, A, I, G [symbol] where “F” is a set of propositions that describes the state of the world and S is used to represent the set of possible states that can be constructed from “F”. “A” is a set of operators or actions available to an agent and produces a set of plans π that transform the initial state I⊆F to the goal state G⊆F. For a deterministic model, each action produces a single next state: A [symbol] a: S→S. The solution to a deterministic problem is a plan(s) represented as a sequence of actions. The execution of a non-deterministic action A [symbol] a: S→{S} can result in more than one possible state.

The solution to a non-deterministic planning problem Π is thus a contingent plan which induces a set of plans. The behavior of the agent is described by one of those plans depending on which outcomes occur at the time of execution. Method 100 considers the space of behaviors represented by Π (M) as the solution space.

For model edits (i.e., step 104), δ: M [symbol] M′ changes one or more conditions in the model to generate a new model. For example, this could involve adding or removing a condition from the initial or goal state or from the set of preconditions and effects of an action. Search in the space of models propagates by the application of one or more such model edits. The size of a model edit is denoted by |δ|.

For abstractions, Abs: M×P→M′ can simulate a collection model edits together that change one or more features of the model. Here “P” is the set of variables that can be projected away. For example, this technique of syntactic state variable projection can be used to determine the right level of abstraction in which to present explanations. This is particularly extended in service of non-deterministic planning used in the tool under study (as described later).

For determinization, determinization is the process of turning a non-deterministic model M into a deterministic one Det(M) where an “all□outcomes” determinization scheme that transforms an action a: S→{Sᵢ} into a set of actions ∀ᵢaᵢ: S→Sᵢ so that all the outcomes of an action with non-deterministic effects can be realized in the determinized model. With the fairness assumption, a solution to Det(M) is also a valid behavior for M, i.e. Π(Det(M))=Π(M).

And, for plan preservation, the model transformation Obs: M×{π} [symbol] M′ receives a model and a (partial) sequence of actions (equivalent to a set of possible plans) and produces a compiled model where this sequence must be preserved (i.e., {π}⊆Π(M′)). In the past, such techniques have been used in the compilation of the goal recognition task into a classical planning problem or in the construction of partial foils from the end user for the purposes of explanation. In the preservation technique used here for deterministic models, the method 100 allows for partial observation of non-determinism as well, in addition to the usual partial plans, to account for the specific needs of the tool under study. This means that an action may be specified in a plan, but its outcome may be left unspecified.

There is no solution when Π(M^{H})≠Π(M)=∅ (i.e., the user asks “why is there no solution”). That is, the domain writer mistakenly thinks that they have a solvable model. As mentioned before, for a model acquisition task, it is not enough to surface a cause for unsolvability, but one must also make sure that the domain writer gets actionable information to remedy the situation. The directive from the planner thus has the following components of a minimum unsolvability, maximal solvability and exemplary plan failure, and subgoals and landmarks.

For the minimal unsolvability, the invention presents to the domain writer the smallest possible abstraction Abs(Det(M),P) such that that this model too does not have any solution.
Find: P
   s.t. Π(Abs(Det(M),P∪G))=∅
   and min |P|
Show: Abs(Det(M),P∪G)

By the properties of the abstraction used, Π(M)≠∅ only if Π(Abs(Det(M)))≠∅. Thus, the domain writer can fix the root cause of unsolvability in this simpler domain first.

For the maximal solvability and exemplary plan failure, while the previous component of the explanation provides a simpler version of the model for the user to debug, it does not illustrate failures of any potential solutions to motivate fixes that the designer might attempt. The following complements it with an illustrative failure in the current model of a plan generated from the maximally solvable abstraction, while letting the domain writer continue fixing the issue on the minimally unsolvable one.
Find: P
   s.t. Π(Abs(Det(M),P∪G))={π}≠∅
   and max |P|
Show: Π(Obs(M,{π}))=∅

The above finds a most complete simplification of the model where a solution exists and illustrates to the user why that solution does not apply to M. The domain writer could also use this sample plan to explore where exactly a possible solution becomes invalid in the current specification, or even use it as a starting point to create more complex foils to investigate further. To improve the efficiency of the search, the invention can restrict the search for an abstraction set over subsets of (F/Pₘᵢₙ) ∪ G (where Pₘᵢₙ is minimum abstracting set). Since the abstraction techniques followed here guarantees that abstractions formed from supersets of Pₘᵢₙ ∪ G will not result in solvable model. Moreover, if Pₘᵢₙ is the only subset of fluents leading to the unsolvability, then (F/Pₘᵢₙ) ∪ G should automatically be a solvable domain. So, the invention starts the search from (F/Pₘᵢₙ) ∪ G and will look at systematically relaxing the model until it gets a solvable one. The invention evaluates this approximation against the exact approach in the evaluations.

For subgoals and landmarks, in addition to presenting the abstractions and an exemplary plan failure, the invention further helps the domain writer debug the problem by presenting them with a subgoal that is necessary for achieving the goal in the current specification but cannot be achieved. This is meant to serve as a prompt for the domain writer for a possible issue to focus on. Landmarks are used for identifying such subgoals.

The invention extracts landmarks directly from the minimally unsolvable model using the following proposition:
Proposition 1: If M is unsolvable, and Abs(M, P) is solvable while Abs(M,P∪{f}) is not, then either the delete relaxation of Abs(M,P∪{f}) is solvable or there must be an unmet landmark corresponding to f.

Proposition 1 follows from the fact that in the abstraction scheme the invention follows, when the delete relaxation of Abs(M, P∪{f})over that of Abs(M,P) is considered, the only possible differences can be that f may be part of preconditions and adds for an action. If this addition makes the delete relaxation unsolvable, then that means that all relaxed plans for Abs(M, P) contained actions that required f as a precondition. The problem becomes more involved when negative preconditions are allowed, as one needs to test whether the possible landmark is f or [symbol] f. Given this proposition, the invention first tests if delete relaxation of Abs(M, P) is solvable so one can extract landmarks from it. Otherwise, one tests if the addition of f in an initial state makes the delete relaxation of Abs(M, P∪{f}) solvable. If it does, then the landmark is f; else it is [symbol] f. While this can lead to more informed landmarks, for cases where the delete relaxation is unsolvable, one would not be able to leverage the ordering of the landmarks to find subgoals appearing earlier in the sequence.

Another case the invention addresses occurs when (for a set of plans {π} presented by the domain writer): {π} ⊆Π(M\hat{ }H) but {π}∉Π(M)(i.e., “why is this not a solution”). This is really a special case of for the above question where one performs the following transformation to solve this:
Set: M←Obs(M, {π})
If: Π(Obs(M))≠∅ (the compilation is solvable) then demonstrate to the user that 1π∈Π(Obs(M, {π})) such that cost (π)>cost(πᵢ)∀πᵢ∈{π}—this means that the foil is not better than anything else already in the solution. At this point, the user can ask a third question of “why is this a solution”.
Else: Follow the above with M.

For “why is this a solution”, this is the case when (for a set of plans {π} presented by the domain writer): {π} [symbol] Π(M\hat{ }H) but {π} ⊆Π(M). Here, the domain designer is surprised that a solution they did not expect is part of Π(M). The provenance of actions along such a solution of M can be communicated to the designer through the visualization of the necessary causal links as done.

Next, specific details of the abstraction and landmark formulation for non-deterministic models that were developed for this invention are discussed.

That is, the input business process can be optimized using automated components and allowing process author to visualize and debug the optimized process by storyboarding to any of identifying optimized pathways (e.g., maybe partial as in the storyboard need not be complete. So, one can say why is A followed by B (though a complete process requires ABCD)). and tracing why that pathway or optimization is allowed, imagining new pathways (e.g., maybe partial) and exploring why that is not a possible pathway or optimization, and/or a variation where no composition or automation was found at all.

In a simulation, the invention may allow the process to generate many simulations or stories and analyze the statistical properties of all of them together, rather than one in isolation. Where issues in the optimization are identified in the optimized process either through storyboarding or simulation, the invention can fix these in the simplest abstraction of the process where the problem still persists. The write-test-debug cycle iterates over fix-in-the-smallest version to test-in-the-full-version and repeats.

Each action “a” in the non-deterministic model is defined as: a= [symbol] prec^{a}, O^{a} [symbol] where prec^{a}⊆F is the set of preconditions that needs to be true for the action a to be executable and O^{a}={o₁^{a}, . . . oₖ^{a}} is the set of k possible outcomes for action “a”. Each outcome is further defined as the tuple oᵢ^{a}= [symbol] addsₒ_{ᵢ}_{^{a}}, delsₒ_{ᵢ}_{^{a}} [symbol] , where addsₒ_{ᵢ}_{^{a}} and delsₒ_{ᵢ}_{^{a}} are the adds and deletes corresponding to the outcome. Definitions 1 and 2 below show that syntactic projection in fact results in logically complete abstractions (i.e., they allow for more behavior and not less).

Definition 1: model abstraction [symbol] ′=Abs( [symbol] , [symbol] ) is logically complete if there exists a surjective mapping from states in [symbol] to [symbol] ′ and Π( [symbol] )⊆Π( [symbol] ′). Now one considers the syntactic projection function Abs: [symbol] ×2^{F} [symbol] [symbol] ′.
Definition 2: Given a non-deterministic model [symbol] and a set affluent [symbol] :Abs_{ν}( [symbol] , [symbol] )=(F/ [symbol] , Â, [symbol] / [symbol] , [symbol] / [symbol] ) where ∀a∈A, [symbol] â∈Â such that: prec^{â}=prec^{a}/ [symbol] and every outcome becomes [symbol] ᵢ^{â}= [symbol] addsₒ_{ᵢ}_{^{a}}/ [symbol] , delsₒ_{ᵢ}_{^{a}}/ [symbol] [symbol] .

This is a logically complete abstraction. Consider a transition (Sᵢ, aᵢ, Sᵢ₊₁) that is valid for t [symbol] , one can see that, Sᵢ ⊆precₐ_{ᵢ} and there must exist an outcome Oₖ^{a}^{ᵢ} for aᵢ such that

$${S}_{i + 1} = ( {S}_{i} / {dels}_{{0}_{k}^{{a}_{i}}} ) ⋃ {adds}_{{0}_{i}^{a}} .$$

Then, there must exist a corresponding transition [symbol] Sᵢ/ [symbol] , âᵢ, Sᵢ₊₁/ [symbol] [symbol] that is that is valid for Absₚ( [symbol] , [symbol] ) with an outcome Oₖ^{â}^{ᵢ}.

With these tools in place, one can generate explanations described in earlier sections by doing a search over the space of non-deterministic models. Specifically, it is next shown that the abstraction of a determined model is the determinization of the abstracted non-deterministic model of proposition 2:
Proposition 2 Given a non-deterministic model [symbol] and a set of fluent [symbol] :Det(Absₚ( [symbol] , [symbol] ))=Absₚ(Det( [symbol] ), [symbol] ).

The determinized model will contain an action for each possible outcome, i.e. ∀Oᵢ^{a}, Det( [symbol] ) contains an action aₒ_{ᵢ}= [symbol] prec^{a}, addsₒ_{ᵢ}_{^{a}}, delsₒ_{ᵢ}_{^{a}} [symbol] . So, the projection of this determinized action will be [symbol] prec^{a}/ [symbol] , addsₒ_{ᵢ}_{^{a}}/ [symbol] , delsₒ_{ᵢ}_{^{a}}/ [symbol] [symbol] , and one would get the same action if one were determinizing based on projected oᵢ^{a}.

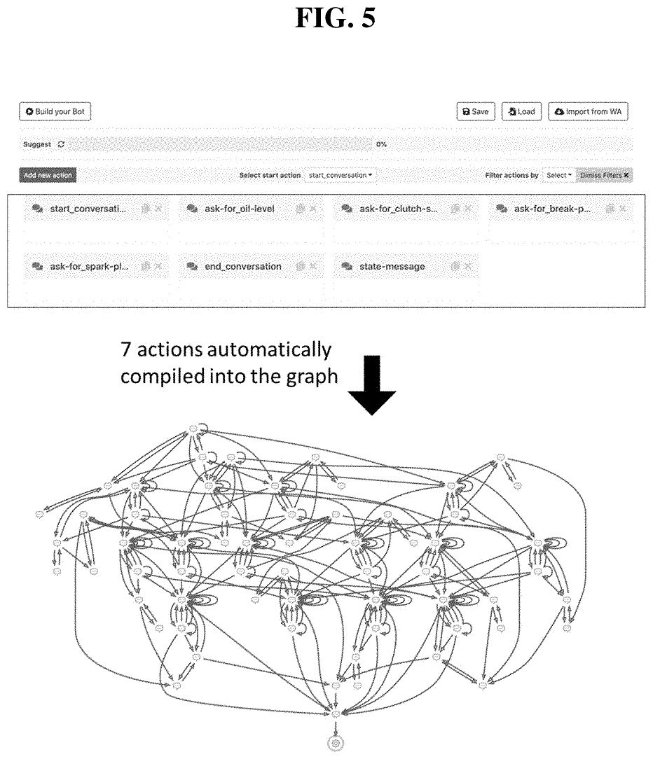

Use cases of the invention are depicted in FIGS. 5 and 7-10 and described hereafter. For example, FIG. 5 depicts a snapshot of the model abstraction in response to unsolvability. Since the model has no solution, there is no generated dialogue plan and the canvas for visualization is empty. The minimal unsolvable abstraction is presented to the designer so that the designer can devise a fix in the simpler model first, before translating that to the full specification. Note how some variables in the domain have disappeared in the minimal abstraction. The designer can toggle back and forth between the full and projected models using the red button, until they are able to devise a fix. The highlight feature communicates to the user which of the projected fluents are associated with which of the actions.

It is noted that an issue in the optimization is identified in the optimized process through the storyboarding and is addressed in an abstraction of the business process where the issue persists. The abstraction is the minimal or simplified process with the same issue (i.e., fix in a minimal model, simulate and test in a maximal model).

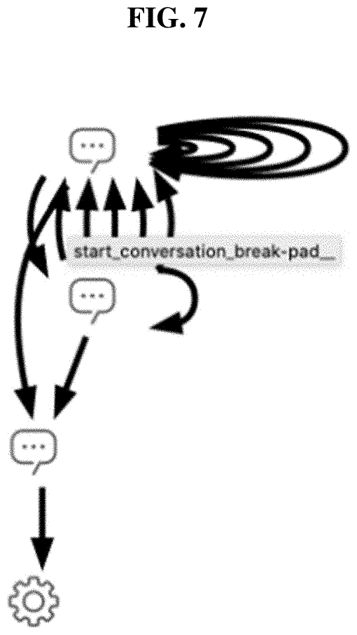

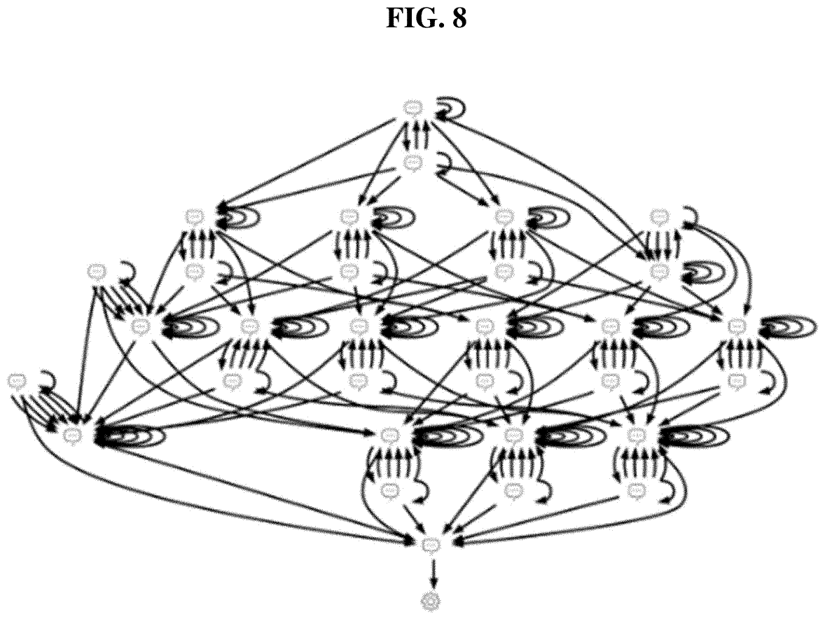

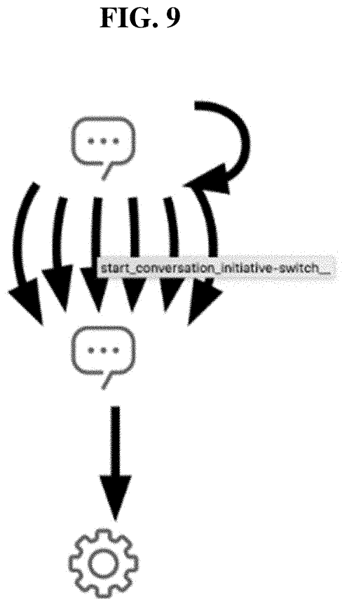

FIG. 7 depicts a solution of the minimal abstraction. Now that the designer was able to fix the simplified domain, and so the designer can try applying the fix to the full specification. FIG. 8 depicts a solution when the fix to the minimal abstraction is applied to the full specification. Now it is at least solvable, but something does not look quite right: the solution does not match the expectation of the domain designer. Now that they have a solution to work with, the designer now directs questions of the form of “Why is this not a solution” (i.e., as shown in FIG. 6). FIG. 9 depicts when the domain writer solves the minimal abstraction again. Applying this fix to the original specification takes the domain writer from FIG. 8 to FIG. 10.

FIG. 10 depicts the final (target) solution as a model that is equivalent to M^{H}. The domain writer does not have access to this until they get there, but instead they continue working on their current specification and its solution (or the lack thereof) until they are satisfied. During the course of this, the system was able to guide the designer along this journey by exposing the mistakes in their past models.

Indeed, FIGS. 5 and 7-10 depict examples of generated dialogue graphs illustrating the reconciliation of M^{H} to M during the method 100. The nodes in the graph stand for agent actions while the edges are the non-deterministic outcomes. The graph is meant to give the reader a sense of the sizes of the abstract solutions. Though the actual labels on the nodes and edges are not visible here, the system does allow the domain designer to drill down further as required.

FIG. 6 exemplarily depicts a snapshot of the method 100 illustrating foil-based interactions when a model is solvable, but does not match expectations. Note how small this projection is (inset), and is even smaller compared to the first unsolvable model in FIG. 5. The corresponding solution in FIG. 9 is similarly smaller than the one in FIG. 7. This showcases an interesting property of the invention that the size of abstractions is non-monotonic in the course of the model acquisition task. On the right, one can see here the foil generated by the invention from the maximal abstraction with diagnostic information on how this fails in the current specification.

With reference to FIG. 6, each of the above use cases is depicted in FIG. 6. In the context of the design of dialogue agents using planning, each “solution” is a potential conversation path allowed by the agent design. Hence, the model acquisition process is one of the dialogue designer ensuring which conversations are allowed and which are not. FIG. 6 depicts a car inspection bot that is a conversational agent tasked with helping in the inspection of a car. The final dialogue plan, as seen in FIG. 10, has 63 nodes and 272 edges and is thus quite comfortably out of scope for the state of the art in dialogue design. The declarative specification as seen in FIG. 5, on the other hand, has just 8 variables and 7 non-deterministic actions. The demonstration considers the following dialogue in this domain:
Bot: Ready to record.
User: Brake pads pass.
Bot: Ok, brake pads pass.
User: What's next?<--initiative switch!Bot: Check the spark plugs.
User: What are the options.
. . .
Bot: Inspection complete!

One part is the potential for initiative switching during the conversation, That is, either the user can go through all the parts by themselves or hand over control to the bot to guide them, or a combination of both. The salient feature of the specification is that there is a catch-all dialogue action to respond to the user when the user has the initiative and a set of actions to ask the user for information when the bot has the initiative. There is one outcome in all of these actions that switches the initiative based on what the user has said, while the other outcomes update the state of the inspection by logging the correct variables based on the user's utterance. Next, the designer's journey is followed to get to this specification.

Related to the first question of “why is there no solution?”, in the user story, the designer has forgotten to add a few critical domain conditions—the outcome for the initiative switch is missing in the catch-all action, while the update for spark plugs is also missing in the corresponding outcome.

As a result, the model has become unsolvable in that there is no way for either the inspector or the bot to drive the initiative and visit all the parts. In FIG. 7, the user is presented with the minimal abstraction where the model is unsolvable. The user fixes this simpler specification to arrive at the solution in FIG. 8. The fix is adding the update for spark plugs when applied to the original specification takes the designer to the current dialogue plan in FIG. 9. This interaction allows the user to find a fix for an unsolvable model by inspecting a much simpler model.

Related to the second question of “Why is this not a solution?”, the missing outcome for the initiative switch in the catch-all action is still missing. As a result, all solutions right now only involve the user driving the conversation and the resulting solution in FIG. 8 looks different from what the designer was expecting (i.e., it does not contain any conversation flow where the bot has the initiative). The domain writer expects the sample conversation to be possible, but does the domain writer knows it is un-solvable, at all? The domain writer gets to query the invention with this foil in FIG. 6. The system again responds with a minimal abstraction to fix, along with a sample plan and an unachieved landmark in the maximally solvable abstraction illustrating why that foil fails in the current model. This not only explains the unsolvability but also provides a powerful directive to fix the model.

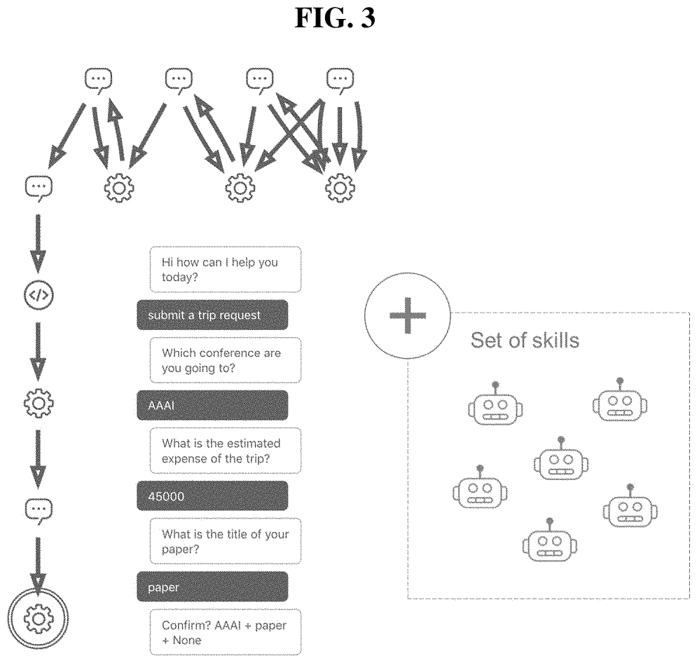

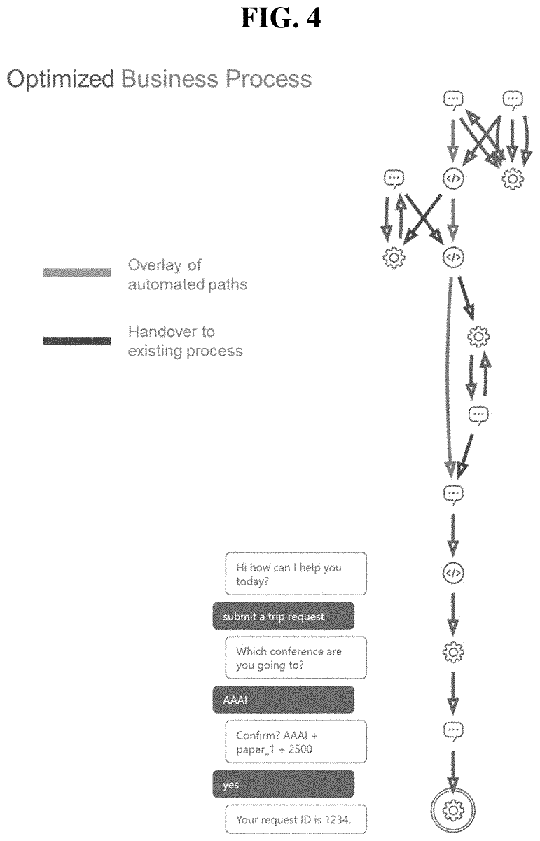

With reference back to FIGS. 3-4, the invention takes the business process of FIG. 3 and simplifies it as shown in FIG. 4. For example, a skill (automation) looks up the author information once the user has declared which conference they are going to, instead of asking all the information from the user (thereby reducing one manual step).

In the above embodiments, the non-determinism is used to also model the optimization of the process using automation, where the automation may or may not work. And, the answers to a storyboard can be used to imagine new products or automation opportunities that do not exist in the current processes being optimized.

Moreover, the answers to a storyboard can be used to upsell to paid tiered products from a source of the automation based on the needs of the process author where the needs of the process author may be a story they want to enable or disable or where the needs of the process author may be statistical properties of the simulation they want to enhance or diminish.

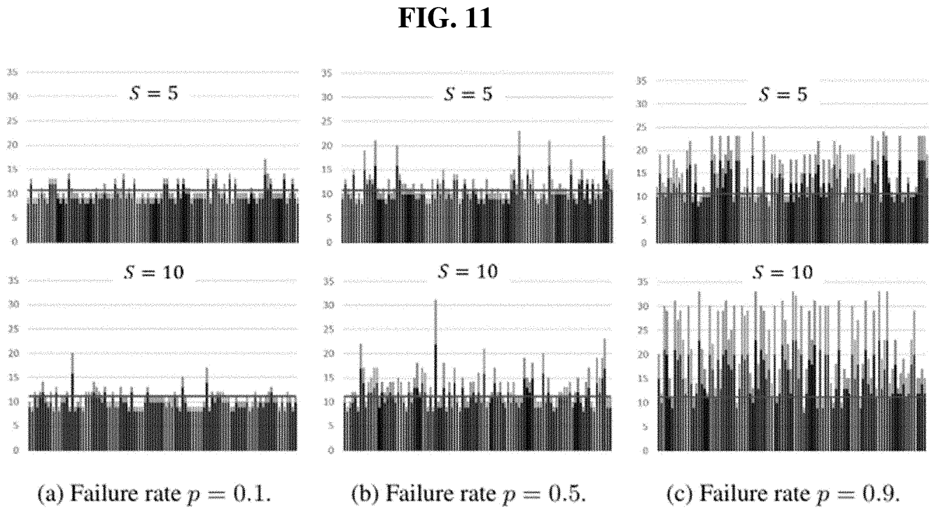

For example, with reference to FIG. 11, FIG. 11 depicts a simulation in the write-test-debug cycle where the administrator simulates many instances of the composition and can analyze at the level of statistical elements of the optimized process rather than a single story (e.g., “Automated fallbacks are leading to 5% increase in make span.”).

Thereby, the method 100 represents a new, low-effort approach to managing and optimizing complex business processes offline. The approach can be used to scale business process management tools with artificial intelligence and automation and scale with decision support technologies quickly in enterprise and public settings.

### Exemplary Aspects, Using a Cloud Computing Environment

Although this detailed description includes an exemplary embodiment of the present invention in a cloud computing environment, it is to be understood that implementation of the teachings recited herein are not limited to such a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time. 100811 Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (Paas): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes. 100921 Referring now to FIG. 12, a schematic of an example of a cloud computing node is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring again to FIG. 12, computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and, program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external circuits 14 such as a keyboard, a pointing circuit, a display 24, etc.; one or more circuits that enable a user to interact with computer system/server 12; and/or any circuits (e.g., network card, modem, etc.) that enable computer system/server 12 to communicate with one or more other computing circuits. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

Referring now to FIG. 13, illustrative cloud computing environment 50 is depicted. As shown, cloud computing environment 50 comprises one or more cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 13 are intended to be illustrative only and that computing nodes 10 and cloud computing environment 50 can communicate with any type of computerized circuit over any type of network and/or network addressable connection (e.g., using a web browser).

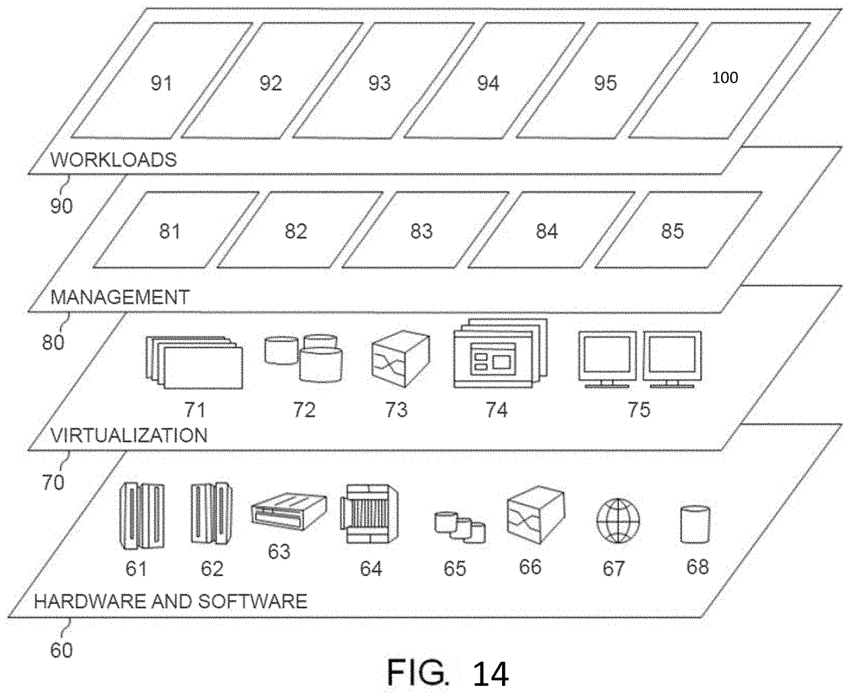

Referring now to FIG. 14, an exemplary set of functional abstraction layers provided by cloud computing environment 50 (FIG. 13) is shown. It should be understood in advance that the components, layers, and functions shown in FIG. 14 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, more particularly relative to the present invention, the optimization method 100.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A computer-implemented optimization method for a number of tasks within a business process that can be automated, the method comprising:
receiving access to an electronic representation of the business process;
optimizing the business process to develop an optimized business process;
displaying the optimized business process as a storyboard using storyboarding; and
receiving an edit of the optimized business process, and automatically making a further edit to the optimized business process.

2. The computer-implemented method of claim 1, wherein the storyboarding enables review, in an offline mode, of the optimized business process.

3. The computer-implemented method of claim 1, wherein the optimizing is performed via an optimization of the business process using an automated component and facilitating a visualization for an author of the business process to debug the optimized process.

4. The computer-implemented method of claim 1, wherein the optimizing is performed via an optimization of the business process using an automated component and facilitating a visualization for an author of the business process to debug the optimized process by identifying, via the storyboarding, an optimized pathway and a tracing why the optimized pathway is allowed.

5. The computer-implemented method of claim 1, wherein the optimized pathway comprises a partial pathway.

6. The computer-implemented method of claim 1, wherein the optimizing is performed via an optimization of the business process using an automated component and facilitating a visualization for an author of the business process to debug the optimized process by imagining, via the storyboarding, a new pathway and exploring why the new pathway is not a possible pathway.

7. The computer-implemented method of claim 1, wherein the optimizing is performed via an optimization of the business process using an automated component and facilitating a visualization for an author of the business process to debug the optimized process by simulation that allows the business process to generate a plurality of simulations and analyzes a statistical property of all of the plurality of simulations together.

8. The computer-implemented method of claim 3, wherein the visualization is performed via a non-deterministic model so that the author of the business process is output different possible outcomes that may happen at a runtime via the visualization.

9. The computer-implemented method of claim 4, wherein an issue in the optimization is identified in the optimized process through the storyboarding and is addressed in an abstraction of the business process where the issue persists.

10. The computer-implemented method of claim 7, wherein an issue in the optimization is identified in the optimized process through the simulation and is addressed in an abstraction of the business process where the issue persists.

11. The computer-implemented method of claim 1, wherein an answer to the storyboard is utilized to imagine a new product or an automation opportunity that does not exist in the business process being optimized.

12. The computer-implemented method of claim 4, wherein an issue in the optimization is identified in the optimized process through the storyboarding and is addressed in a landmark of the business process to provide feedback while answering questions on the storyboarding.

13. The computer-implemented method of claim 12, wherein a necessity of the landmark is established via a causal link of relationships between skills and a manual step in the business process.

14. The computer-implemented method of claim 1, embodied in a cloud-computing environment.

15. A computer program product for optimization for a number of tasks within a business process that can be automated, the computer program product comprising a computer-readable storage medium having program instructions embodied therewith, the program instructions executable by a computer to cause the computer to perform:
receiving access to an electronic representation of the business process;
optimizing the business process to develop an optimized business process;
displaying the optimized business process as a storyboard using storyboarding; and
receiving an edit of the optimized business process, and automatically making a further edit to the optimized business process.

16. The computer program product of claim 15, wherein the storyboarding enables review of the optimized business process.

17. The computer program product of claim 15, wherein the optimizing is performed via an optimization of the business process using an automated component and facilitating a visualization for an author of the business process to debug the optimized process.

18. The computer program product of claim 15, wherein the optimizing is performed via an optimization of the business process using an automated component and facilitating a visualization for an author of the business process to debug the optimized process by identifying, via the storyboarding, an optimized pathway and a tracing why the optimized pathway is allowed.

19. An optimization system for a number of tasks within a business process that can be automated, said system comprising:
a processor; and
a memory, the memory storing instructions to cause the processor to perform:
receiving access to an electronic representation of the business process;
optimizing the business process to develop an optimized business process;
displaying the optimized business process as a storyboard using storyboarding; and
receiving an edit of the optimized business process, and automatically making a further edit to the optimized business process.

20. The system of claim 19, embodied in a cloud-computing environment.
